(19) United States
(12) Patent Application Publication
(10) Pub. No.: US 2019/0071349 A1
(43) Pub. Date: Mar. 7, 2019

(54) SOLAR CONTROL GLAZING COMPRISING A LAYER OF A NiCuCr ALLOY

(71) Applicant: SAINT-GOBAIN GLASS FRANCE, Courbevoie (FR)

(72) Inventor: Laura Jane SINGH, Paris (FR)

(73) Assignee: SAINT-GOBAIN GLASS FRANCE, Courbevoie (FR)

(21) Appl. No.: 16/077,501

(22) PCT Filed: Feb. 24, 2017
(86) PCT No.: PCT/FR2017/050411

§ 371 Date: Aug. 13, 2018

(30) Foreign Application Priority Data
Feb. 26, 2016 (FR) 1651625

(51) Int. Cl. C03C 17/36; G02B 5/20

(52) U.S. Cl. CPC C03C 17/3649; C03C 17/3618; C03C 17/3626; C03C 2218/156; C03C 17/366; C03C 17/3681; G02B 5/208; C03C 17/3639

(57) ABSTRACT

A glazing that has a solar control property includes at least one glass substrate on which a stack of layers is deposited. The stack includes at least one layer consisting of an alloy comprising nickel, copper and chromium, in which alloy the atomic percentage of nickel is greater than 70% and less than 94%, the atomic percentage of copper is greater than 5% and less than 25% and in which the atomic percentage of chromium is greater than 1% and less than 15%.

The invention relates to the field of glass substrates or articles, in particular of the glazing for buildings type, comprising, at their surface, coatings of the thin layer type conferring on them solar control properties. Such a glazing can also be applied in the motor vehicle field. The term glazing is understood to mean, within the meaning of the present invention, any glass product composed of one or more glass substrates, in particular single glazings, double glazings, triple glazings, and the like.

Such glazings are provided with stacks of thin layers which act on the incident solar radiation by absorption and by reflection. They are combined under the designation of solar control glazing. They are used either essentially to provide protection from the sun (solar protection function) or essentially to provide thermal insulation of the passenger compartment or dwelling (low-e function).

The term “solar protection” is thus understood to mean, within the meaning of the present invention, the ability of the glazing to limit the radiant flux, in particular the infrared (IR) radiation, passing through it from the outside toward the inside of the dwelling or of the passenger compartment.

The term “low-e” is understood to mean a glazing provided with at least one functional layer conferring on it a normal emissivity Eₙ of less than 50%, indeed even of less than 40%, the emissivity being defined by the relationship:

εₙ=1−Rₙ

in which Rₙ is the reflection factor along the normal (according to Annex A of the international standard ISO 10292) to the glazing.

Generally, all the light and energy characteristics presented in the present description are obtained according to the principles and methods described in the international standards ISO 9050 (2003) and ISO 10292 (1994), relating to the determination of the light, solar and energy characteristics of the glazings used in glass for the construction industry.

These coatings are conventionally deposited by deposition techniques of the CVD type for the simplest or generally, at present, by vacuum sputtering deposition techniques, often known as magnetron sputtering in the field, in particular when the coating consists of a complex stack of successive layers, the thicknesses of which do not exceed a few nanometers or a few tens of nanometers.

Generally, the stacks made of thin layers exhibit solar control properties essentially by the intrinsic properties of one or more active layers, designated as functional layers in the present description. The term “active layer” or “functional layer” is thus understood to mean a layer which acts substantially on the flux of solar radiation passing through said glazing. Such an active layer, in a known way, can operate either mainly in mode of reflection of the incident infrared radiation or mainly in mode of absorption of said infrared radiation. Generally, these solar protection layers operate partly by reflection and partly by absorption, as already explained above.

In particular, the most efficient stacks sold at present incorporate at least one functional metal layer of the silver type operating essentially on the mode of the reflection of a major part of the incident IR (infrared) radiation. Their known emissivity does not exceed a few percent. These stacks are thus mainly used as glazings of the low-e type for the thermal insulation of buildings. However, these layers are very sensitive to moisture and are thus exclusively used in double glazings, on face 2 or 3 of the latter in order to be protected from moisture. The stacks according to the invention do not comprise such layers of the silver type, or even layers of the gold or platinum type, or only in very negligible amounts, in particular in the form of unavoidable impurities.

Other metal layers having a solar protection function have also been reported in the field, comprising functional layers of the Nb, Ta or W type or nitrides of these metals, as described, for example, in the application WO01/21540. Within such layers, the solar radiation is this time predominantly absorbed not selectively by the functional layer or layers, that is to say that the IR radiation (that is to say, the wavelength of which is between approximately 780 nm and 2500 nm) and the visible radiation (the wavelength of which is between approximately 380 and 780 nm) are absorbed without distinction. In such glazings, the values of the normal emissivity εₙ are generally higher. Lower emissivity values can only be obtained when the functional layer is relatively thick, in particular of at least 20 nm for niobium metal. Due to the nonselective absorption of this same layer, the light transmittance coefficients of such glazings are necessarily very low, generally far lower than 30. In the end, in the light of such characteristics, it does not appear possible to obtain, from such stacks, solar control glazings combining relatively low normal emissivities, typically of less than 50% and in particular of the order of 40% or even 35%, while retaining a sufficiently high light transmittance, that is to say typically of greater than 30%.

The publication of patent EP 747 329 B2 describes stacks, the functional layer of which consists of pure nickel. As nickel is a ferromagnetic metal, it however proves to be very difficult and expensive to deposit in a layer, on the industrial scale, by conventional deposition techniques of the magnetron sputtering type, including the cathode sputtering of a metal target of the material to be deposited, using the forces of a magnetic field.

In order to avoid this problem, the patent EP 747 329 B2 indicates the possible use of alloys predominantly comprising nickel and chromium, the proportion of Ni being at least 10 atom %.

The application EP 067 257 A1 alternatively describes the use, as functional solar protection layer, of an alloy comprising nickel and copper, in proportions of 1 to 25% by weight of nickel and 75 to 99% by weight of copper.

The application GB 1 309 881 describes a transparent glazing comprising a functional layer predominantly containing copper and from 5 to 15% by weight of nickel.

The patent application WO2013/057425 describes stacks, the functional layers of which are based on an alloy of copper and of nickel, the atomic percentage of copper being between 1% and 25% and the atomic percentage of nickel being between 75% and 99%. While the glazings described in this publication are entirely satisfactory, the solar control stack placed on an exterior surface has for this reason to be as resistant as possible to chemical attacks and in particular to acid attacks, which can result either from its exposure to humid ambient air, in particular in hot countries and very humid countries, or from the cleaning of the windows by cleaning products, which are often acidic. It is thus useful to further improve the performance levels of such stacks, in particular of resilience to chemical attacks, without, however, limiting their optical performance levels.

The aim of the present invention is thus to provide glazings comprising a stack of layers conferring on them solar control properties as described above, while exhibiting a light transmittance T_{L} typically of greater than 30%, preferably of greater than or equal to 40% or even of greater than or equal to 50% and a low normal emissivity εₙ preferably of less than 50%, indeed even of less than 45% or even of less than 40%, said stack being durable over time, in particular when it is directly positioned on a face of the glazing exposed toward the interior or even the exterior of the building or of the passenger compartment, without specific precaution. Another aim of the present invention is to provide solar protection glazings, said stack of which is capable of undergoing a heat treatment, such as a tempering, a bending or more generally a heat treatment at higher temperatures without loss of its optical and energy properties.

A glazing according to the invention also makes it possible to select the radiation passing through it, by favoring instead the transmittance of light waves, that is to say the wavelength of which is between approximately 380 and 780 nm, and by limiting the passage of infrared radiation, the wavelength of which is greater than 780 nm.

According to the invention, it thus becomes possible to maintain a high illumination of the room or of the passenger compartment protected by the glazing, while minimizing the amount of heat entering therein.

According to another aspect, the glazing according to the present invention also exhibits thermal insulation properties by virtue of the low-e properties of the layer used, making it possible to limit the exchanges of heat between the inside and the outside of the building.

According to another advantage of the present invention, the glazings provided with the stacks according to the invention are simple to produce, in comparison with other known glazings having solar protection properties, in particular those comprising a silver-based stack.

In addition, they are resistant to moisture, to scratching and to acid attacks.

In particular, the glazings according to the invention exhibit an improved longevity, in the sense that their initial properties, in particular their variation in coloration and their thermal or solar insulation properties, only vary very slightly under the chemical attacks to which they are subjected during their anticipated use.

They can thus advantageously be used as simple glazing (just one glass substrate), the stack preferably being turned toward the internal face of the building or of the passenger compartment to be protected.

More specifically, the present invention relates to a glazing having a solar control property comprising at least one glass substrate on which a stack of layers is deposited, said stack comprising at least one layer consisting of an alloy, preferably a metal alloy, comprising nickel, copper and chromium, in which alloy the atomic percentage of nickel is greater than 70% and less than 94%, the atomic percentage of copper is greater than 5% and less than 25% and in which the atomic percentage of chromium is greater than 1% and less than 15%.

The term “metal alloy” is understood to mean that the alloy essentially contains metal elements and in particular does not comprise a heteroatom, such as oxygen or nitrogen, other than in the form of unavoidable impurities. In addition, the alloy preferably does not contain carbon, other than in the form of unavoidable impurities.

Within the meaning of the present invention, a functional layer in a stack is responsible for the solar control properties of the glazing or at least of a major part of these properties.

According to preferred embodiments of the present invention, which can very obviously if appropriate be combined with one another:
The atomic percentage of copper in the alloy is greater than the atomic percentage of chromium, preferably by at least 3%, in particular by at least 5%.
The atomic percentage of copper in the alloy is between 5% and 20%, in particular between 7% and 15%.
The atomic percentage of nickel in the alloy is between 75% and 90%, in particular between 78% and 85%.
The atomic percentage of chromium in the alloy is between 2% and 12%, in particular between 3% and 10%.
The thickness of said functional layer is between 5 and 25 nanometers, preferably between 8 and 15 nanometers.
The alloy is essentially composed of nickel, of copper and of chromium, indeed even only comprises nickel, copper and chromium, the other elements then being present only in the form of unavoidable impurities.
The stack comprises or even consists of the sequence of the following layers, starting from the surface of the glass substrate:
   one or more lower layers for protection of the functional layer from the migration of the alkali metal ions resulting from the glass substrate, preferably based on or consisting of an oxide, of a nitride or of an oxynitride, with a geometric thickness, in total, of between 5 and 150 nm,
   said functional layer of said alloy comprising or essentially composed of nickel, of copper and of chromium,
   one or more upper layers for protection of the functional layer from atmospheric oxygen, preferably based on or consisting of an oxide, of a nitride or of an oxynitride, in particular during a heat treatment, such as a tempering or an annealing, said layer or layers having a geometric thickness, in total, of between 5 and 150 nm.
The lower and upper protective layer or layers are chosen from silicon nitride optionally doped with Al, Zr, B, aluminum nitride AlN, tin oxide, a mixed zinc tin oxide Sn_{y}Zn_{z}Oₓ, silicon oxide SiO₂, undoped titanium oxide TiO₂ or silicon oxynitrides SiOₓN_{y}.
The stack comprises the sequence of the following layers, starting from the surface of the glass substrate:
   a lower layer with a thickness of between 5 and 150 nm, preferably between 30 and 70 nm, of silicon nitride optionally doped with Al, Zr, B or of aluminum nitride AlN,
   said functional layer of said alloy comprising or essentially composed of nickel, of copper and of chromium,
   an upper layer with a thickness of between 5 and 150 nm, preferably between 30 and 70 nm, of silicon nitride optionally doped with Al, Zr, B or of aluminum nitride AlN.
The stack comprises at least two functional layers of said alloy comprising or essentially composed of nickel, of copper and of chromium as described above, each of said layers being separated in the stack from the following layer by at least one intermediate layer of a dielectric material.
Said intermediate layer comprises at least one layer of a material chosen from silicon nitride optionally doped with Al, Zr, B, aluminum nitride AlN, tin oxide, a mixed zinc tin oxide, silicon oxide SiO₂, undoped titanium oxide TiO₂ or silicon oxynitrides SiOₓN_{y}.
The stack comprises the sequence of the following layers, starting from the surface of the glass substrate:
   a lower layer with a thickness of between 5 and 150 nm, preferably between 30 and 70 nm, of silicon nitride optionally doped with Al, Zr, B or of aluminum nitride AlN,
   a first functional layer of said alloy comprising or essentially composed of nickel, of copper and of chromium as described above, the thickness of said functional layer being in particular between 5 and 25 nm, preferably between 5 and 10 nm,
   an intermediate layer with a thickness of between 5 and 150 nm, preferably between 5 and 50 nm, very particularly between 5 and 15 nm, comprising at least one layer of a material chosen from silicon nitride optionally doped with Al, Zr, B, aluminum nitride AlN, tin oxide, a mixed zinc tin oxide Sn_{y}Zn_{z}Oₓ, silicon oxide SiO₂, undoped titanium oxide TiO₂ or silicon oxynitrides SiOₓN_{y}, preferably silicon nitride optionally doped with Al, Zr, B,
   a second functional layer of said alloy comprising or essentially composed of nickel, of copper and of chromium, the thickness of said functional layer being in particular between 5 and 25 nm, preferably between 5 and 10 nm,
   an upper layer with a thickness of between 5 and 150 nm, preferably between 30 and 70 nm, of silicon nitride optionally doped with Al, Zr, B or of aluminum nitride AlN.
The stack moreover comprises additional protective layers for the functional layer or layers consisting of a metal chosen from the group consisting of Ti, Mo and Al or of an alloy comprising at least one of these elements, or also of an alloy of nickel and of chromium NiCr, said additional protective layers being positioned in contact with and respectively above and below the functional layer or layers and having a geometric thickness of between approximately 1 nm and approximately 5 nm, preferably between 1 and 3 nm. Preferably, said additional protective layers consist of Ti or of NiCr.

A process for the manufacture of a solar protection glazing comprises, for example, the following stages:
manufacture of a glass substrate,
deposition, on the glass substrate, of a stack of layers by a magnetron-assisted vacuum cathode sputtering technique, the solar protection functional layer being obtained by sputtering a target comprising or essentially composed of an alloy of nickel, of copper and of chromium in a residual atmosphere of a neutral gas, such as argon, the atomic percentage of nickel being greater than 70% and less than 94%, the atomic percentage of copper being greater than 5% and less than 25% and the atomic percentage of chromium being greater than 1% and less than 15%.

An alternative process for the manufacture of a solar protection glazing comprises, for example, the following stages:
manufacture of a glass substrate,
deposition, on the glass substrate, of a stack of layers by a magnetron-assisted vacuum cathode sputtering technique, the solar protection functional layer being obtained by cosputtering of a target essentially composed of an alloy of two of the three metals described above, preferably an alloy of nickel and of copper, and of a target essentially composed of the third metal described above, preferably chromium, in a residual atmosphere of a neutral gas, such as argon, the conditions of the sputtering of said two targets being adjusted so that the atomic percentage of nickel in the layer is greater than 70% and less than 94%, the atomic percentage of copper is greater than 5% and less than 25% and the atomic percentage of chromium being greater than 1% and less than 15%.

The expression “essentially composed of” is understood to mean, within the meaning of the present description, that the alloy constituting the functional layer comprises only or very predominantly the elements copper and nickel, the other elements then being present only in a very minor concentration which has no or virtually no influence on the desired properties of the material. The term “unavoidable impurities” is thus understood to mean that the presence in the alloy of nickel, of copper and of chromium of certain additional elements, in particular metal elements, cannot be avoided due typically to the presence of these impurities in the sources of copper, of nickel and of chromium initially used or due to the method of deposition of the layer of nickel, of copper and of chromium. Generally, the atomic proportion of each of the elements regarded as impurity in the alloy is less than 1 atom %, is preferably of less than 0.5 atom % and is very preferably less than 0.1 atom %.

The examples which follow are given as purely illustrative and do not limit, under any of the aspects described above, the scope of the present invention. For the purposes of comparison, all the stacks of the examples which follow are synthesized on the same Planilux® glass substrate. All the layers of the stacks were deposited according to well known conventional techniques for depositions under vacuum by magnetron sputtering.

### EXAMPLE 1 (COMPARATIVE)

In this example in accordance with the application WO2013/057425, a stack consisting of the sequence of following layers:

| | | | | | | |
|---|---|---|---|---|---|---|
| Glass | /Si₃N₄ | /NiCr | /Ni₈₀Cu₂₀* | /NiCr | /Si₃N₄ | /TiOₓ |
| | (60 nm) | (1 nm) | (8 nm) | (1 nm) | (34 nm) | (9 nm) |

*80 atom % of nickel, 20 atom % of copper

was deposited, according to conventional magnetron techniques, on a substrate made of glass of the Planilux® type sold by the applicant company.

The layers of oxides and of nitrides are obtained according to the techniques of the art in the magnetron frame. The functional metal layer made of NiCu is obtained by the same magnetron sputtering technique from a target consisting of an alloy comprising approximately 80 atom % of nickel and approximately 20 atom % of copper. No difficulty was observed during the deposition of the layer by the magnetic-field-assisted (magnetron) sputtering techniques.

It was confirmed by Castaing microprobe analysis (also known as EPMA or electron probe microanalysis) that the composition of the metal layer finally obtained corresponds substantially to the composition of the initial target. More specifically, the composition of the alloy layer was measured beforehand by EPMA on a single layer deposited on the same substrate.

The substrate provided with its stack is subsequently subjected to a heat treatment consisting of a heating operation at 650° C. for ten minutes, followed by a tempering operation. This treatment is representative of the conditions undergone by the glazing if the latter has to be tempered.

The light transmittance factor T_{L} and the normal emissivity before and after the heat treatment were measured in this comparative glazing according to the standards described above.

### EXAMPLE 2 (ACCORDING TO THE INVENTION)

In this example according to the invention, the same stack as for example 1 is deposited on a glass substrate of the Planilux® type, except that the functional layer is deposited by cosputtering from the target used in example 1 (80/20 atomic alloy of nickel and copper) and from an additional target made of chromium, in one and the same compartment of the magnetron device. The power applied to the two cathodes is adjusted in order to obtain a functional layer of nickel and of copper and of a small percentage of chromium.

The composition of the metal alloy layer is determined by Castaing microprobe analysis (also known as EPMA or electron probe microanalysis) according to the same principles as described above.

The stack deposited consists of the sequence of following layers:

| | | | | | | |
|---|---|---|---|---|---|---|
| Glass | /Si₃N₄ | /NiCr | /Ni₈₀Cu₁₉Cr₁* | /NiCr | /Si₃N₄ | /TiOₓ |
| | (60 nm) | (1 nm) | (8 nm) | (1 nm) | (34 nm) | (9 nm) |

*alloy consisting of 80 atom % of nickel, 19 atom % of copper and 1 atom % of chromium

No difficulty was observed during the deposition of the layer by the magnetron techniques, despite the high concentration of nickel in the alloy.

As for example 1, the substrate provided with its stack is subsequently subjected to a heat treatment consisting of a heating operation at 650° C. for ten minutes, followed by a tempering operation.

The light transmittance factor T_{L} and the normal emissivity before and after the heat treatment are measured on this glazing according to the invention under the same conditions as above according to the standards described above.

### EXAMPLE 3 (ACCORDING TO THE INVENTION)

In this example, a procedure identical to that of example 2 is carried out in order to obtain a substantially identical stack by the magnetron sputtering technique but the powers exerted on the two targets during the cosputtering are varied so as to increase the content of chromium in the alloy.

The composition of the metal alloy layer is determined by Castaing microprobe analysis as indicated above.

The stack deposited this time consists of the sequence of following layers:

| | | | | | | |
|---|---|---|---|---|---|---|
| Glass | /Si₃N₄ | /NiCr | /Ni₇₆Cu₁₈Cr₆* | /NiCr | /Si₃N₄ | /TiOₓ |
| | (60 nm) | (1 nm) | (8 nm) | (1 nm) | (34 nm) | (9 nm) |

*alloy consisting of 76 atom % of nickel, 18 atom % of copper and 6 atom % of chromium

As for example 1, the substrate provided with a stack is subsequently subjected to a heat treatment consisting of a heating operation at 650° C. for ten minutes, followed by a tempering operation.

The light transmittance factor T_{L} and the normal emissivity before and after the heat treatment are measured on this glazing according to the invention under the same conditions as above according to the standards described above.

### EXAMPLE 4 (ACCORDING TO THE INVENTION)

In this example, a procedure identical to that of example 3 is carried out in order to obtain a substantially identical stack by the magnetron sputtering technique but the power exerted on the target made of chromium during the cosputtering of the two targets is further increased, so as to further increase the chromium content in the alloy.

The composition of the metal alloy layer is also determined by Castaing microprobe analysis as indicated above.

The stack deposited this time consists of the sequence of following layers:

| | | | | | | |
|---|---|---|---|---|---|---|
| Glass | /Si₃N₄ | /NiCr | /Ni₇₃Cu₁₇Cr₁₀* | /NiCr | /Si₃N₄ | /TiOₓ |
| | (60 nm) | (1 nm) | (8 nm) | (1 nm) | (34 nm) | (9 nm) |

*alloy consisting of 73 atom % of nickel, 17 atom % of copper and 10 atom % of chromium

### EXAMPLE 5 (COMPARATIVE)

In this example according to the invention, the same stack as for example 1 is deposited on a glass substrate of the Planilux® type, except that the functional layer is deposited by cosputtering from the target used in example 1 (80/20 atomic alloy of nickel and of copper) and from a molybdenum target, in one and the same compartment of the magnetron device. The power applied to the two cathodes is adjusted in order to obtain a functional layer of nickel and of copper and of a small percentage of molybdenum.

The composition of the metal alloy layer is here again determined by Castaing microprobe analysis.

The stack deposited consists of the sequence of following layers:

| | | | | | | |
|---|---|---|---|---|---|---|
| Glass | /Si₃N₄ | /NiCr | /Ni₇₇Cu₁₆Mo₇* | /NiCr | /Si₃N₄ | /TiOₓ |
| | (60 nm) | (1 nm) | (8 nm) | (1 nm) | (34 nm) | (9 nm) |

*alloy consisting of 77 atom % of nickel, 16 atom % of copper and 7 atom % of molybdenum

As for the preceding examples, the substrate that is provided with a stack is subsequently subjected to a heat treatment consisting of a heating operation at 650° C. for ten minutes, followed by a tempering operation.

The light transmittance factor T_{L} and the normal emissivity before and after the heat treatment are measured on this glazing according to the invention under the same conditions as above according to the standards described above.

The values of the measurements carried out on the samples according to examples 2 to 4 according to the invention and according to comparative examples 1 and 5 are combined in table 1 below:

TABLE 1

| | Example 1 | Example 2 | Example 3 | Example 4 | Example 5 |
|---|---|---|---|---|---|
| | Functional layer | | | | |
| | Ni₈₀Cu₂₀ | Ni₈₀Cu₁₉Cr₁ | Ni₇₆Cu₁₈Cr₆ | Ni₇₃Cu₁₇Cr₁₀ | Ni₇₅Cu₁₆Mo₉ |
| Active layer | 8 | 8 | 8 | 8 | 8 |
| thickness (nm) | | | | | |
| T_{L} (%) | 52 | 52 | 51 | 50 | 49 |
| after tempering | | | | | |
| εₙ (%) | 34 | 34 | 37 | 41 | 47 |
| after tempering | | | | | |
| SF (solar factor) | 48 | 47 | 47 | 47 | 46 |

The results given in table 1 above indicate that the main optical and thermal (solar control) properties do not vary substantially with the incorporation in the NiCu alloy of a minor amount of chromium.

In order to confirm the chemical resistances of the functional layers deposited according to the preceding examples, the resistance to acids of the glazings described above was measured by the SO₂ test according to the conditions described in the standard EN1096-2 (January 2001), Annex C.

The normal emissivity of the stack is measured before beginning the test and then after 35 test cycles. A variation in the emissivity Δεₙ is thus measured and is given in table 2 below as a percentage.

The variation in color of the glazing in transmission, on conclusion of the acid treatment (35 cycles), was quantified, in the L*, a*, b* colorimetric system and under normal incidence, by using the quantity ΔE conventionally used in the L*, a*, b* international system and defined by the relationship:

ΔE=\sqrt{(Δa*)²+(Δb*)²+(ΔL*)²}

The measurements are carried out using a Minolta ISO 1175 spectrometer. The values of the measurements carried out on the different samples after the 35 cycles of the SO₂ test are combined in table 2 below:

TABLE 2

| | Example 1 | Example 2 | Example 3 | Example 4 | Example 5* |
|---|---|---|---|---|---|
| | Functional layer | | | | |
| | Ni₈₀Cu₂₀ | Ni₈₀Cu₁₉Cr₁ | Ni₇₆Cu₁₈Cr₆ | Ni₇₃Cu₁₇Cr₁₀ | Ni₇₅Cu₁₆Mo₉ |
| Δεₙ (%) | 1 | 0.6 | 0.2 | 0.2 | 5.2 |
| ΔE | 2.7 | 1.6 | 0.9 | 1.1 | 8.1 |

*interrupted after 25 SO₂ cycles

The preceding SO₂ test of durability to acid attacks shows the superiority of the stacks according to the invention, comprising an alloy of nickel, of copper and of chromium. In particular, it is demonstrated the incorporation of chromium in the initial NiCu alloy makes it possible to considerably reduce the variations in emissivity and in coloration of the glazing in acid environments, making it possible to guarantee their initial properties over a long period, whatever the conditions of use, in particular externally.

The mechanical strength properties of the glazings provided with the stacks were measured on the samples of the preceding examples 1 to 5.
The test carried out is a Taber test on the thermally treated glazings of the preceding examples 1 to 4.

The Taber test measures the resistance to abrasion of the surface of the glazing on which the stack of layers has been deposited. A 5135 Abraser abrasion tester from Taber Industries subjects the coating to continuous rubbing using an abrasive disc. More specifically, an abrasive grinding wheel of CS10F grade is rotated, with application of a force of 4.9N (500 g), over the surface of the glazing to be evaluated. After 1000 revolutions, the glazings are recovered and the mechanical strength of the tested surface is evaluated by the variation of the light transmittance and the variation in the haze before and after the test.

The light transmittance is measured according to the standards described above.
The term “haze”, measured as a percentage, is understood to mean, within the meaning of the present invention, the loss by scattering of the light, that is to say, conventionally, the ratio of the scattered part of the light (diffuse fraction or T_{d}) to the light directly transmitted through the glazing (T_{L}), generally expressed as a percentage. The diffuse transmittance thus measures the light fraction scattered by the layer deposited at the surface of the glass substrate. The haze is conventionally measured by spectroscopy techniques, the integration over the whole of the visible region (380-780 nm) making it possible to determine the normal transmittance T_{L} and the diffuse transmittance T_{d}. Such a measurement is obtained by the use of a haze meter. The apparatus used is a Haze-Gard® device sold by BYK-Gardner.
The results obtained are given in table 3 below:

TABLE 3

Taber 1000 cycles

| Example | Functional layer | ΔT_{L} | ΔHaze |
|---|---|---|---|
| 1 | Ni₈₀Cu₂₀ | 3.1 | 4.0 |
| 2 | Ni₈₀Cu₁₉Cr₁ | 2 | 5.8 |
| 3 | Ni₇₆Cu₁₈Cr₆ | 0.8 | 5.0 |
| 4 | Ni₇₃Cu₁₇Cr₁₀ | 0.5 | 3.9 |

The results given in table 3 above demonstrate the resistance to friction of the stacks according to the invention, in particular with regard to the reference stack according to example 1.

1. A glazing having a solar control property comprising:
at least one glass substrate on which a stack of layers is deposited, said stack comprising at least one functional layer consisting of an alloy comprising nickel, copper and chromium, in which alloy the atomic percentage of nickel is greater than 70% and less than 94%, the atomic percentage of copper is greater than 5% and less than 25% and in which the atomic percentage of chromium is greater than 1% and less than 15%.

2. The glazing as claimed in claim 1, in which the atomic percentage of copper is greater than the atomic percentage of chromium by at least 3%.

3. The glazing as claimed in claim 1, in which the atomic percentage of copper in the alloy is between 5% and 15%.

4. The glazing as claimed in claim 1, in which the atomic percentage of nickel in the alloy is between 75% and 90%.

5. The glazing as claimed in claim 1, in which the atomic percentage of chromium in the alloy is between 2% and 10%.

6. The glazing as claimed in claim 1, in which the thickness of said functional layer is between 5 and 25 nanometers.

7. The glazing as claimed in claim 1, in which the alloy is essentially composed of nickel, of copper and of chromium.

8. The glazing as claimed in claim 1, in which the alloy does not comprise a heteroatom, such as nitrogen or oxygen, or carbon.

9. The glazing as claimed in claim 1, in which the stack consists of the sequence of the following layers, starting from the surface of the glass substrate:
one or more lower layers for protection of the functional layer from the migration of the alkali metal ions resulting from the glass substrate, with a geometric thickness, in total, of between 5 and 150 nm,
the functional layer consisting of said alloy,
one or more upper layers for protection of the functional layer from atmospheric oxygen, said layer or layers having a geometric thickness, in total, of between 5 and 150 nm.

10. The glazing as claimed in claim 9, in which the lower and upper protective layer or layers are chosen from silicon nitride doped with Al, Zr, B, aluminum nitride AlN, tin oxide, a mixed zinc tin oxide Sn_{y}Zn_{z}Oₓ, silicon oxide SiO₂, undoped titanium oxide TiO₂ or silicon oxynitrides SiOₓN_{y}.

11. The glazing as claimed in claim 1, in which the stack comprises the sequence of the following layers, starting from the surface of the glass substrate:
a lower layer with a thickness of between 5 and 150 nm, of silicon nitride optionally doped with Al, Zr, B or of aluminum nitride AlN,
a functional layer consisting of said alloy,
an upper layer with a thickness of between 5 and 150 nm, of silicon nitride doped with Al, Zr, B or of aluminum nitride AlN.

12. The glazing as claimed in claim 1, in which the stack comprises at least two functional layers consisting of said alloy comprising or consisting of nickel, of copper and of chromium, each of said layers being separated in the stack from the following layer by at least one intermediate layer of a dielectric material.

13. The glazing as claimed in claim 12, in which said intermediate layer comprises at least one layer of a material chosen from silicon nitride doped with Al, Zr, B, aluminum nitride AlN, tin oxide, a mixed zinc tin oxide Sn_{y}Zn_{z}Oₓ, silicon oxide SiO₂, undoped titanium oxide TiO₂ or silicon oxynitrides SiOₓN_{y}.

14. The glazing as claimed in claim 13, in which the stack comprises the sequence of the following layers, starting from the surface of the glass substrate:
a lower layer with a thickness of between 5 and 150 nm, of silicon nitride doped with Al, Zr, B or of aluminum nitride AlN,
a first functional layer essentially composed of said alloy comprising or essentially composed of nickel, of copper and of chromium,
an intermediate layer with a thickness of between 5 and 150 nm comprising at least one layer of a material chosen from silicon nitride doped with Al, Zr, B, aluminum nitride AlN, tin oxide, a mixed zinc tin oxide Sn_{y}Zn_{z}Oₓ, silicon oxide SiO₂, undoped titanium oxide TiO₂ or silicon oxynitrides SiOₓN_{y}, doped silicon nitride,
a second functional layer essentially composed of said alloy comprising or essentially composed of nickel, of copper and of chromium,
an upper layer with a thickness of between 5 and 150 nm, of silicon nitride doped with Al, Zr, B or of aluminum nitride AlN.

15. The glazing as claimed in claim 1, in which the stack additionally comprises protective layers of a metal chosen from the group consisting of Ti, Mo and Al or of an alloy comprising at least one of these elements, or also protective layers of an alloy of nickel and of chromium, said layers being positioned in contact with and above and below the functional layer or layers, each protective layer having a geometric thickness of between approximately 1 nm and approximately 5 nm.

16. The glazing as claimed in claim 11, in which the thickness of the lower layer is between 30 and 70 nm, and the thickness of the upper layer is between 30 and 70 nm.

17. The glazing as claimed in claim 14, in which the thickness of the lower layer is between 30 and 70 nm, and the thickness of the upper layer is between 30 and 70 nm.
